(19) United States
(12) Patent Application Publication
(10) Pub. No.: US 2016/0183654 A1
(43) Pub. Date: Jun. 30, 2016

(54) BAG WITH ELECTROLUMINESCENT LIGHTING SYSTEM

(71) Applicant: Tamara Ann Leuty, New York, NY (US)

(72) Inventor: Tamara Ann Leuty, New York, NY (US)

(21) Appl. No.: 14/843,378

(22) Filed: Sep. 2, 2015

Related U.S. Application Data
(63) Continuation-in-part of application No. 13/666,022, filed on Nov. 1, 2012, now Pat. No. 9,144,282.
(60) Provisional application No. 61/554,262, filed on Nov. 1, 2011.
(60) Provisional application No. 61/554,078, filed on Nov. 1, 2011.
(60) Provisional application No. 62/111,328, filed on Feb. 3, 2015.

(51) Int. Cl. A45C 15/06; F21V 23/02; A45C 3/06; A45C 13/02; A45C 15/04; F21V 23/04; F21V 33/00

(52) U.S. Cl. CPC A45C 15/06; F21V 23/04; F21V 23/02; F21V 33/0004; A45C 13/02; A45C 15/04; A45C 3/06; F21W 2131/30

(57) ABSTRACT

The present invention includes a bag(s) (in the usual meaning of the term and as defined below) with an electroluminescent light source(s) (in the usual meaning of the term and as defined below) and methods of making the same. More specifically, the invention includes bags having laminated electroluminescent light source(s).

### CROSS-REFERENCE TO RELATED APPLICATIONS

This application is a continuation-in-part of and claims priority from U.S. Nonprovisional application Ser. No. 13/666,022, filed Nov. 1, 2012. Additionally, this application claims priority from U.S. Provisional Application No. 62/111,328, filed Feb. 3, 2015.

### BACKGROUND OF THE INVENTION

The present invention relates to a bag(s) (in the usual meaning of the term and as defined below) with an electroluminescent light source(s) (in the usual meaning of the term and as defined below) and methods of making the same. More specifically, the invention relates to bags having laminated electroluminescent light source(s).

People often carry items in bags or as bags such as hand bags, shoulder bags, clutches, purses, totes, wallets, makeup bags, duffel bags, suitcases, briefcases, luggage, etc. The interior of a bag is often dark, making it difficult to distinguish and obtain a specific item from the bag, when carrying more than one item. This problem has sought to be addressed by including a light in the bag. However, there are many drawbacks to including a light in a bag.

When light sources are placed at the top of a bag this can result in shadows being cast by the items in the bag, thus creating additional elements to distinguish from the various items being carried in the bag. Also, a bag cannot be washed when it includes a light source or when it includes a power source. Further, lights usually create heat that can pose a fire or burn risk. It can also be difficult to replace batteries and the wires for connecting the light source can get tangled in the bag. Many bag lighting devices are bulky and take up space in the bag that could otherwise be used to carry additional items. The present invention addresses these problems in a stylish and attractive manner.

### SUMMARY OF THE INVENTION

The present invention provides a bag having an electroluminescent lighting system. The system provides a bag with a light protected by lamination, and/or a bag with a light positioned to illuminate the items in a bag and avoid and/or minimize the casting of confusing shadows, and/or a light-containing bag that can be washed, and/or a light for a bag which minimizes or avoids a fire and/or burn risk, and/or a bag having an easily replaceable power source, and/or a bag with a light which avoids wires getting tangled in the bag, and/or a bag with a lighting device that is not bulky, and/or a bag with a light that is stylish and attractive.

The present invention provides a bag having a lighting system. The bag having: an exterior surface and an interior surface; a top portion, a bottom portion and one or more side portions; at least one electroluminescent light source; at least one light switch for turning the at least one electroluminescent light source on and/or off; and a laminate covering for the at least one electroluminescent light source.

In one embodiment, the light given off by the at least one electroluminescent light source is in a hue conducive to enabling vision in the presence of low ambient light.

In another embodiment, the at least one electroluminescent light source comprises a flexible, elastic material

In another embodiment, the at least one electroluminescent light source is permeable or impermeable.

In another embodiment, the at least one electroluminescent light source is located on at least one of the one or more side portions proximate the top portion.

In another embodiment, the laminate covering extends beyond the perimeter of the at least one electroluminescent light source to form an edge of laminating material.

In another embodiment, the bag also includes an interior liner abutting the interior surface and the edge of laminating material is attached to the interior liner.

In another embodiment, the at least one electroluminescent light is located between the interior surface and the interior liner.

In another embodiment, the at least one electroluminescent light is mounted on the interior liner on the surface of the liner opposite the surface facing the interior surface of the bag.

In another embodiment, the interior liner has an opening for displaying at least a portion of the at least one electroluminescent light source.

In another embodiment, at least one of the at least one light switches is an automatic light switch which automatically turns on at least one of the at least one electroluminescent light sources in response to the bag being opened and/or in response to detecting a predetermined level of ambient light.

In another embodiment, at least one of the at least one light switches is at least one manual light switch.

In another embodiment, the bag has at least one opening and at least one of the at least one manual light switches is located at or near at least one of the openings in the bag.

In another embodiment, the bag also has at least one of a permanent and/or removable battery.

In another embodiment, the bag also includes a pocket to hold the battery and wherein the battery further comprises a connector to connect the at least one battery to the at least one electroluminescent light source.

In another embodiment, the pocket has an opening for the connector and/or an object connected to the battery to exit the pocket.

In another embodiment, the opening in the pocket also includes a protecting device.

In another embodiment, the protecting device is a grommet.

In another embodiment the said light panel, showing durability of this light panel, and including the said wiring, are washable, water resistant, and heat resistant (can be placed in a washer and/or dryer) so that a simple removal of the said battery unit is all that is required to wash the whole bag including the light panel.

In another embodiment additionally comprising at least one mirror.

In another embodiment the said at least one mirror is attached to the lining of the flap closure section of a bag, the said laminate covering and the said at least one electroluminescent light source encased in the laminate covering, is placed above, below, or partially or wholly surrounding the perimeter of the at least one mirror.

In another embodiment the said at least one electroluminescent light source is located on, or near, the top of the bag, or on more than one side portion, or most, or all of the entire perimeter of the inside of the bag, so to produce light which covers the entire perimeter of the inside and/or top of the bag.

### BRIEF DESCRIPTION OF THE SEVERAL VIEWS OF THE DRAWING

FIG. 1 is an open top front perspective drawing illustrating an embodiment of an evening clutch.

FIG. 2 is a top view drawing illustrating another embodiment of an evening clutch.

FIG. 3 is an open top view perspective drawing illustrating another embodiment of an evening clutch.

FIG. 4 is a top view drawing illustrating another embodiment of an evening clutch.

FIG. 5 is an open top and front perspective drawing illustrating another embodiment of an evening clutch.

FIG. 6 is an open top view drawing illustrating evening clutch.

FIG. 7 is a closed front side view of evening clutch.

FIG. 8 is an open top-view drawing illustrating evening clutch.

FIG. 9 illustrates an embodiment of an electroluminescent lighting system.

FIG. 10 is a front view of another embodiment of a bag with bottom lighting system (lighting system can be sides and/or bottom).

FIG. 11 is top view drawing of a hand bag with bottom lighting.

FIG. 12 is a front view of another embodiment of a handbag with lighting system under interior zipper and close to top of bag on lining attached to back wall.

FIG. 13 is side and front-view drawing illustrating another embodiment of a bag showing a magnet flap in up or open position circle in flap show a magnet placement, it also shows on off switch on opposite side from light system.

FIG. 14 top view illustrating another embodiment of a bag with lighting panel on above the middle backside lining of bag, shows wire going through grommet of battery pocket within lining, shows other wire from battery pocket going to magnet switch through lining.

FIG. 15 is a front view drawing illustrating another embodiment of a bag showing battery, wire, and light placement.

FIG. 16 is a drawing of the battery pack illustrating an embodiment of a battery pack with A and B for locations the wires go to.

FIG. 17 illustrates another embodiment of an electroluminescent lighting system showing A plug going to light panel, B plug going to switch, shows three sides of battery pack, screw to take apart or hold panel in place.

FIG. 18 illustrates an embodiment of an electroluminescent light strip/panel.

FIG. 19 shows a wire coming from behind battery pack to magnet closure, shows a mirror placed below the lighting.

FIG. 20 shows the light panel surrounding a mirror.

FIGS. 21-23 show three angles of handbag with lighted mirror.

FIG. 24 shows a plug and bag with charging system that connects with plug.

FIG. 25 shows a brief case with the invention showing a possible placement.

FIGS. 26-33 show embodiments of the invention in luggage and depict various views with vertical lighting system. Other embodiments could be horizontal lighting system placement.

FIG. 26 is a top open view of lighting system vertical in luggage.

FIG. 27 is a left side view of lighting system vertical in luggage.

FIG. 28 is a right side view of lighting system vertical in luggage.

FIG. 29 is a top closed view of vertical lighting system in luggage.

FIG. 30 is a front view of vertical lighting system in luggage.

FIG. 31 is a front side angle view of vertical lighting system in luggage.

FIG. 32 is a side view of luggage with vertical lighting.

FIG. 33 is a front view of luggage with vertical lighting.

The drawings are not necessarily to scale. Like numbers used in the figures refer to like components, steps, and the like. However, it will be understood that the use of a number to refer to a component in a given figure is not intended to limit the component in another figure labeled with the same number.

### DETAILED DESCRIPTION OF THE INVENTION

In one embodiment, the bag includes, can be, or is a clutch, a tote, a briefcase, a wallet, a handbag, a shoulder bag, a duffel bag, a garment bag, a suitcase and/or a makeup bag, or luggage. In at least one embodiment, the bag includes a clutch. In at least one embodiment, the bag includes a tote. In at least one embodiment, the bag includes or is a briefcase. In at least one embodiment, the bag includes or is a handbag. In at least one embodiment, the bag includes or is a shoulder bag. In at least one embodiment, the bag includes or is a makeup bag. In at least one embodiment, the bag includes or is a wallet. In at least one embodiment, the bag includes or is a duffel bag. In at least one embodiment, the bag includes or is a suitcase. In at least one embodiment, the bag includes or is a garment bag. The bag is not limited to any design, material, or shape found in any of the drawings of any of the embodiments described herein.

In at least one embodiment, the bag includes or is luggage.

In at least one embodiment, the battery power pack includes one or more rechargeable batteries, one or more non-rechargeable batteries, or a combination thereof. In at least one embodiment, the battery power pack includes one or more rechargeable batteries. In at least one embodiment, the battery power pack includes one or more non-rechargeable batteries. In at least one embodiment, the battery power pack includes one or more rechargeable batteries and one or more non-rechargeable batteries.

In at least one embodiment, any or all of the connections and/or wiring to power the light source and/or switch are hidden under the lining. In at least one embodiment the hidden items are shown with dotted lines to indicate they are not seen.

In at least one embodiment, the light source is laminated so it can be safely washed.

In at least one embodiment, the electroluminescent light panel includes an inverter battery, an inverter, and one or more electroluminescent materials.

The present invention provides a bag having a lighting system. The bag having: an exterior surface and an interior surface; a top portion, a bottom portion and one or more side portions; at least one electroluminescent light source (“Lighting Panel”); at least one light switch (which can be coupled to the light and/or the, magnetic switch) for turning the at least one electroluminescent light source on and/or off; and a laminate covering for the at least one electroluminescent light source (which can be laminated by heat, pressure, ultra violet (UV) light, etc.).

In at least one embodiment, the light given off by the at least one electroluminescent light source is in a hue conducive to enabling vision in the presence of low ambient light. Although electroluminescent lights are available in most any color.

In at least another embodiment, the at least one electroluminescent light source comprises a flexible, elastic material. This enables the light source to mold to the shape of the bag and freely move with the material of the bag. In at least one embodiment, the light source covers the bottom of the bag and is molded upward to cover the bottom portion of one or more sides of the bag.

In at least another embodiment, the at least one electroluminescent light source is permeable or impermeable.

In at least another embodiment, the at least one electroluminescent light source is located on at least one of the one or more side portions proximate the top portion.

In at least another embodiment, the laminate covering extends beyond the perimeter of the at least one electroluminescent light source to form an edge of laminating material. The edge of laminating material enables easy attachment of the light source to the bag.

In at least another embodiment, the bag also includes an interior liner abutting the interior surface and the edge of laminating material is attached (using any means or any device for attaching, e.g., glue, sewing thread, Velcro, snaps, zippers) to the interior liner. Although the light source and/or its laminated edge can be attached by any means or device to any part of the bag, not just the interior liner.

In at least another embodiment, the at least one electroluminescent light is located between the interior surface and the interior liner.

In at least another embodiment, the at least one electroluminescent light is mounted on the interior liner on the surface of the liner opposite the surface facing the interior surface of the bag.

In at least another embodiment, the interior liner has an opening for displaying at least a portion of the at least one electroluminescent light source.

In at least another embodiment, at least one of the at least one light switches is an automatic light switch which automatically turns on at least one of the at least one electroluminescent light sources in response to the bag being opened and/or in response to detecting a predetermined level of ambient light.

In at least another embodiment, at least one of the at least one light switches is at least one manual light switch.

In at least another embodiment, the bag has at least one opening and at least one of the at least one manual light switches is located at or near at least one of the openings in the bag.

In at least another embodiment, the bag also has at least one of a permanent and/or removable battery.

In at least another embodiment, the bag also includes a pocket (which can be affixed to the outside of a bag to minimize the number of items in the main section of the bag) to hold the battery and wherein the battery further comprises a connector to connect the at least one battery to the at least one electroluminescent light source.

In at least another embodiment, the pocket has an opening for the connector and/or an object connected to the battery to exit the pocket.

In at least another embodiment, the opening in the pocket also includes a protecting device.

In at least another embodiment, the protecting device is a grommet (which can be of any protective material, e.g., metal, plastic, rubber, fabric, wood, etc.)

The detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The detailed description is, therefore, not to be taken in a limiting sense, and the scope of the present invention is defined by the appended claims and their equivalents.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

The figures may have all, some, or none of the numbers associated with the descriptions below, if the numbers are not located on a particular figure then ignore them as if not here as they plan to be inserted for the non-provisional filing.

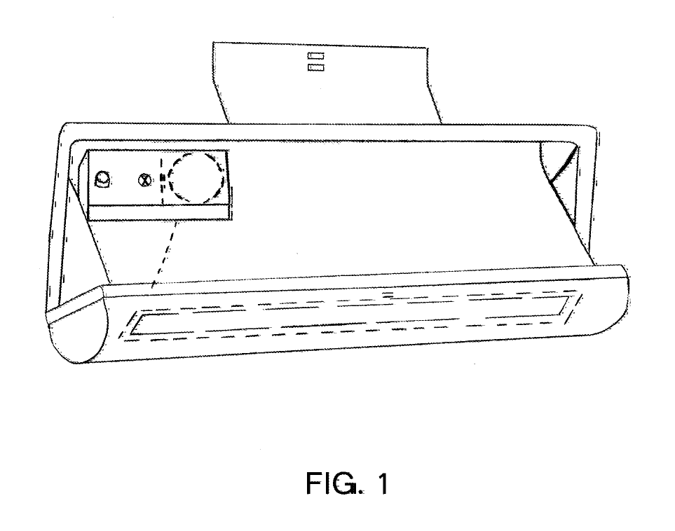

FIG. 1 is an open top front view of an evening clutch. The clutch can be made of any desired material, such as metal, leather, fabric, wood, straw, etc. The clutch includes a first shell, a second shell a first interior liner, a second interior liner, a manual push-button on/off switch, a battery and/or battery power pack, an electroluminescent light strip shown with dotted lines as it is hidden from view here, and a latch or closing/opening device. The battery power pack is located between the interior surface of first shell and the first surface of the interior liner and is hidden from view. The electroluminescent light strip is located on the second surface of the second interior liner also hidden from view on outside of clutch. In at least one embodiment, first shell and the second shell are symmetrical. In one embodiment, first shell and the second shell are not symmetrical. In at least one embodiment, the electroluminescent light strip includes a protective covering. In at least one embodiment, the protective covering includes a transparent fabric covering. In at least one embodiment, the protective covering includes a transparent plastic covering. In at least one embodiment, the protective covering includes a laminating material. The manual push-button on/off switch, the battery power pack, and the electroluminescent light strip are each electrically coupled together with one or more wires. The battery power pack may include one or more batteries. In at least one embodiment, the one or more batteries are rechargeable batteries. In at least one embodiment, the one or more batteries are non-rechargeable batteries. In at least one embodiment, at least one electroluminescent light strip is a flexible electroluminescent light panel. In at least one embodiment, the electroluminescent light strip is non-flexible, electroluminescent light panel. In at least one embodiment, the electroluminescent light strip includes an inverter battery (not shown), an inverter (not shown), and one or more electroluminescent materials (not shown). In at least one embodiment, the first shell and the second shell are each a rigid metal shell. In at least one embodiment, the first shell and the second shell are each a flexible metal shell. In at least one embodiment, an optional handle is a flexible optional handle. In at least one embodiment, the optional handle is a rigid optional handle. The rigid optional handle may be a rigid metal optional handle, a rigid wood optional handle, a rigid plastic optional handle, a rigid leather optional handle, or the like. In one embodiment, the optional handle is a flexible optional handle. The flexible optional handle may be a rope, chain, strap, etc. The handle may be metal, wood, plastic, leather or the like. The latch is used to secure the contents of the metal purse by interfacing with notch after the purse is closed. When the purse is open, the user depresses the manual push-button on/off switch and the power flows from the battery power pack to electroluminescent light panel that lights up the interior of the purse.

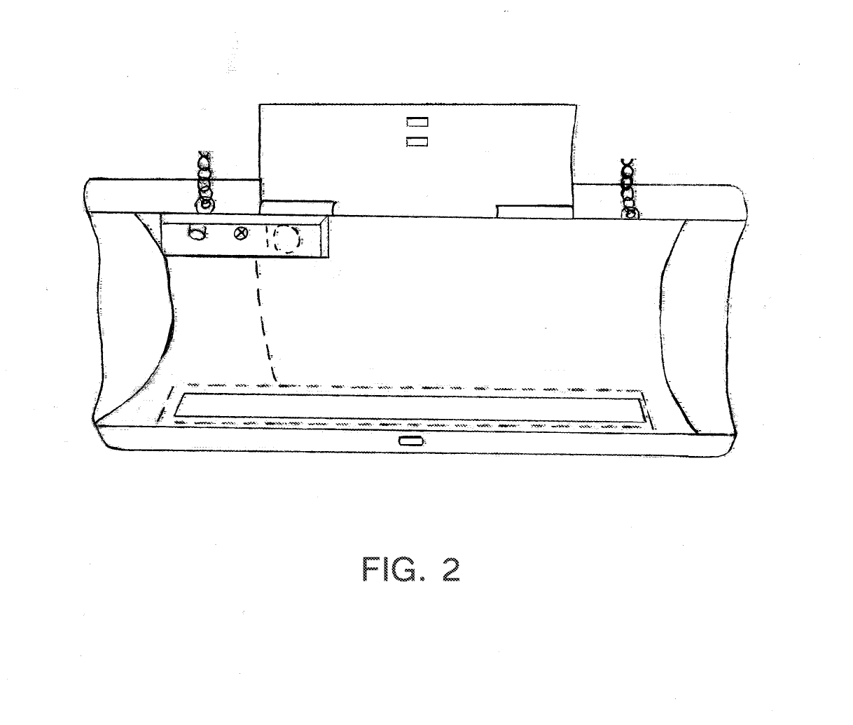

FIG. 2 is a top-view drawing illustrating an evening clutch. The clutch includes a first shell, a second shell a first interior liner, a second interior liner, a manual push-button on/off switch, a battery and/or a battery power pack, an electroluminescent light, an optional handle (not shown here), and a latch. The manual push-button on/off switch, the battery power pack, and the electroluminescent light are each electrically coupled together with one or more wires. In one embodiment, the battery power pack includes one or more batteries. In at least one embodiment, first shell and the second shell are symmetrical. In one embodiment, first shell and the second shell are not symmetrical. The latch is used to secure the contents of the purse by interfacing with notch after the purse is closed. When the purse is open, the user depresses the manual push-button on/off switch and the power flows from the battery power pack to electroluminescent light panel that lights up the interior of the purse.

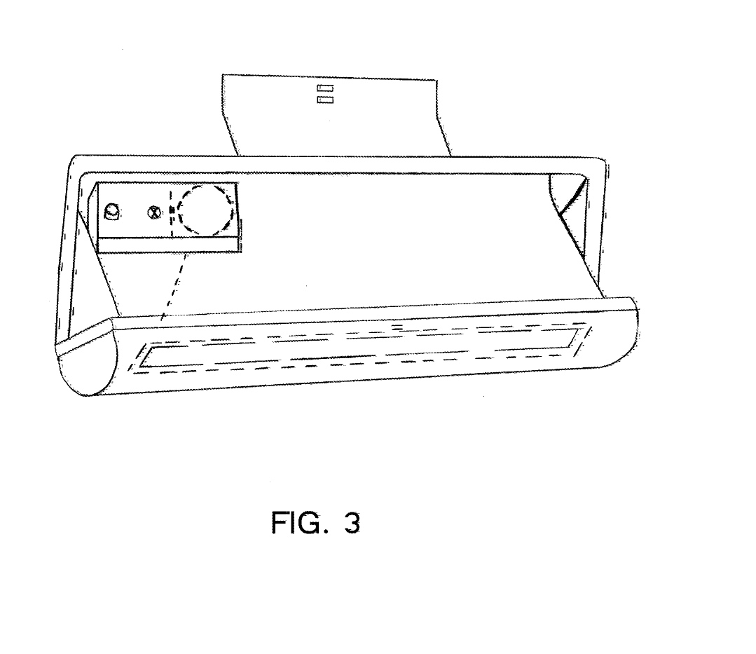

FIG. 3 is an open top view drawing illustrating a metal clutch. The clutch includes a first shell, a second shell, a first interior liner, a second interior liner, magnetic contact on/off switch, a battery power pack, an electroluminescent light, and a latch. The battery and/or battery power pack is located between the interior surface of first shell and the first surface of the interior liner. The electroluminescent light is located on the second surface of the second interior liner. In at least one embodiment, the electroluminescent light includes a protective covering. In one embodiment, the protective covering includes a transparent fabric covering. In at least one embodiment, the protective covering includes a transparent plastic covering and/or a laminated covering. In at least one embodiment, metal shell and the second shell are symmetrical. In one embodiment, first shell and the second shell are not symmetrical. The magnetic contact switch, the battery power pack, and the electroluminescent light are each electrically coupled together with one or more wires. The battery power pack includes one or more batteries. The latch is used to secure the contents of the purse by interfacing with notch after the purse is closed. When the purse is open, the connection between the magnetic contact on/off switch and the magnetic contact connector is broken and the power flows from the battery power pack to electroluminescent light and lights up the interior of the purse.

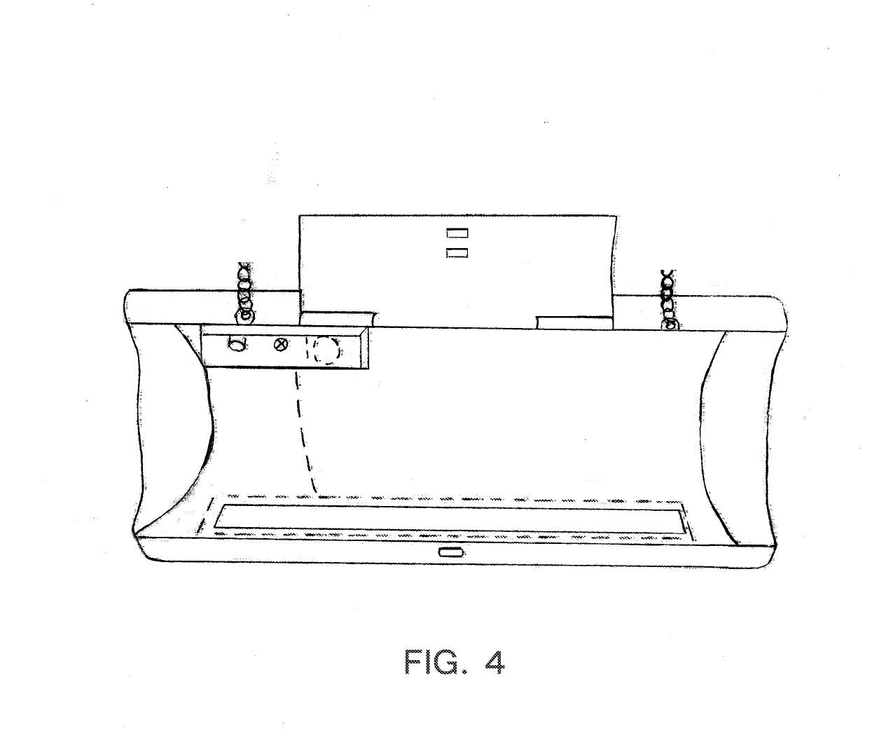

FIG. 4 is a top-view drawing illustrating a metal clutch. The clutch includes a first shell, a second shell, a first interior liner, a second interior liner, magnetic contact on/off switch, a battery power pack, an electroluminescent light, an optional strap (not shown), and a latch. The battery power pack is located between the interior surface of first shell and the first surface of the interior liner. The electroluminescent light is located on the second surface of the second interior liner. In one embodiment, first shell and the second shell are symmetrical. In one embodiment, first shell and the second shell are not symmetrical. The magnetic contact switch, the battery power pack, and the electroluminescent light are each electrically coupled together with one or more wires. The battery power pack includes one or more batteries. The latch is used to secure the contents of the purse by interfacing with notch after the purse is closed. When the purse is open, the connection between the magnetic contact on/off switch and the magnetic contact connector is broken and the power flows from the battery power pack to electroluminescent light panel and lights up the interior of the purse.

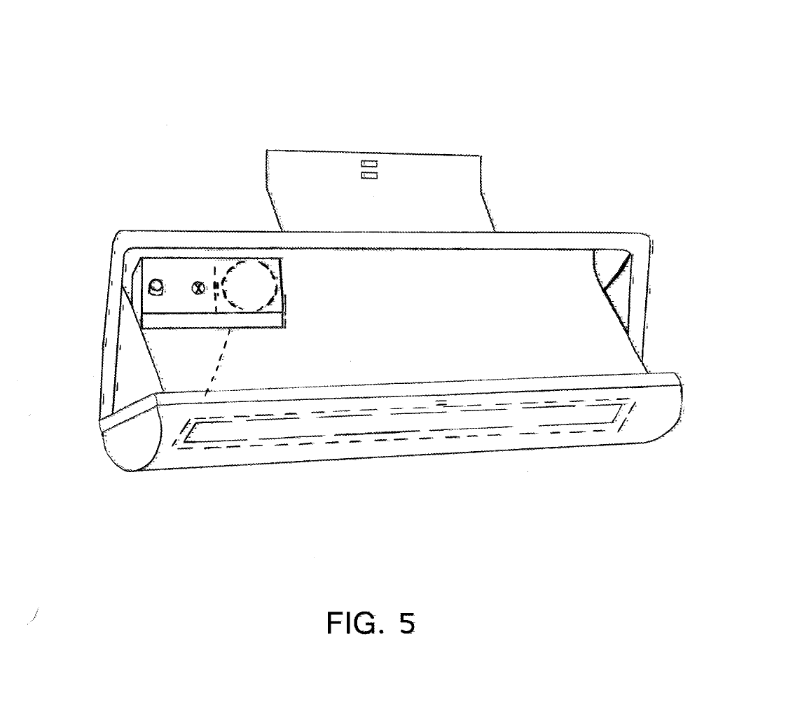

FIG. 5 is open top and front view illustrating a metal clutch. The clutch includes a first shell, a second shell a first interior liner, a second interior liner, manual push button on/off switch, a battery power pack, an electroluminescent light, and a latch. The battery power pack is located between the interior surface of first shell and the first surface of the interior liner. The electroluminescent light is located on the second surface of the second interior liner. In one embodiment, the electroluminescent light includes a protective covering. In one embodiment, the protective covering includes a transparent fabric covering. In one embodiment, the protective covering includes a transparent plastic covering and/or a laminating material. In at least one embodiment, first shell and the second shell are symmetrical. In at least one embodiment, first shell and the second shell are not symmetrical. The manual push button on/off switch, the battery power pack, and the electroluminescent light are each electrically coupled together with one or more wires. The battery power pack includes one or more batteries. The latch is used to secure the contents of the purse by interfacing with notch after the purse is closed. When the purse is open, the user depresses the manual push-button on/off switch and the power flows from the battery power pack to electroluminescent light and lights up the interior of the purse.

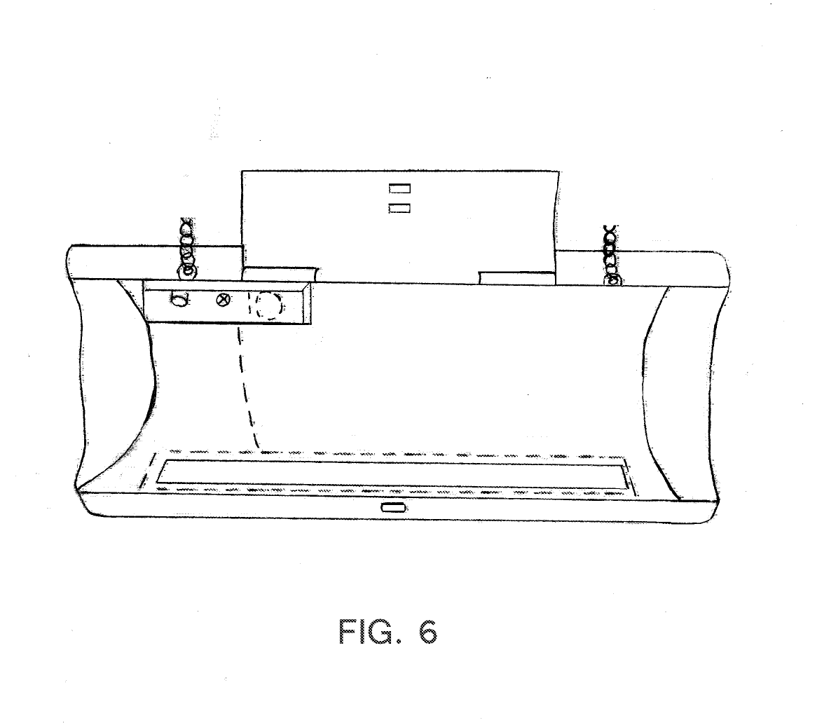

FIG. 6 is an open top-view drawing illustrating an exemplary metal clutch. The clutch includes a first shell, a second shell, a first interior liner, a second interior liner, manual push button on/off switch, a battery power pack, an electroluminescent light, an optional strap, and a latch. The battery power pack is located between the interior surface of first shell and the first surface of the interior liner. The electroluminescent panel is located on the second surface of the second interior liner. In at least one embodiment, first shell and the second shell are symmetrical. In one embodiment, first shell and the second metal are not symmetrical. The manual push button on/off switch, the battery power pack, and the electroluminescent light are each electrically coupled together with one or more wires. The battery power pack includes one or more batteries. The latch is used to secure the contents of the purse by interfacing with notch after the purse is closed. When the purse is open, the user depresses the manual push-button on/off switch and the power flows from the battery power pack to electroluminescent light and lights up the interior of the purse.

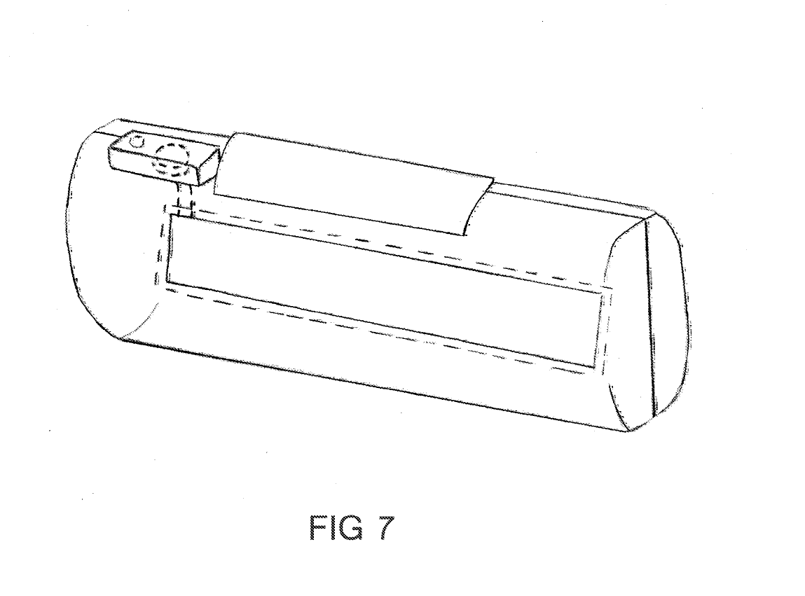

FIG. 7 is a closed front and side view of an exemplary metal clutch. The clutch includes a first shell a second shell, a first interior liner, a second interior liner, magnetic contact on/off switch, a battery power pack, an electroluminescent light, and a latch. The battery power pack is located between the interior surface of first shell and the first surface of the interior liner. The electroluminescent light is located on the second surface of the second interior liner. In one embodiment, the electroluminescent light includes a protective covering. One example of the protective covering is a laminating material and the light is sandwiched between two sections of laminating material and laminated by pressure, heat, etc. In at least one embodiment, first shell and the second shell are symmetrical. In one embodiment, first metal and the second are not symmetrical. The magnetic contact on/off switch, the battery power pack, and the electroluminescent light are each electrically coupled together with one or more wires. The battery power pack includes one or more batteries. The latch is used to secure the contents of the purse by interfacing with notch after the purse is closed. When the purse is open, the connection between the magnetic contact on/off switch and the magnetic contact connector is broken and the power flows from the battery power pack to electroluminescent light and lights up the interior of the purse.

FIG. 8 is an open top-view drawing illustrating an exemplary metal clutch. The clutch includes a first shell, a second shell, a first interior liner, a second interior liner, magnetic contact on/off switch, a battery power pack, an electroluminescent light, an optional strap (not shown), and a latch. The battery power pack is located between the interior surface of first shell and the first surface of the interior liner. The electroluminescent light is located on the second surface of the second interior liner. In at least one embodiment, first shell and the second shell are symmetrical. In at least one embodiment, first shell and the second shell are not symmetrical. The magnetic contact on/off switch, the battery power pack, and the electroluminescent light are each electrically coupled together with one or more wires. The battery power pack includes one or more batteries. The latch is used to secure the contents of the purse by interfacing with notch after the purse is closed. When the purse is open, the connection between the magnetic contact on/off switch and the magnetic contact connector is broken and the power flows from the battery power pack to electroluminescent light panel and lights up the interior of the purse.

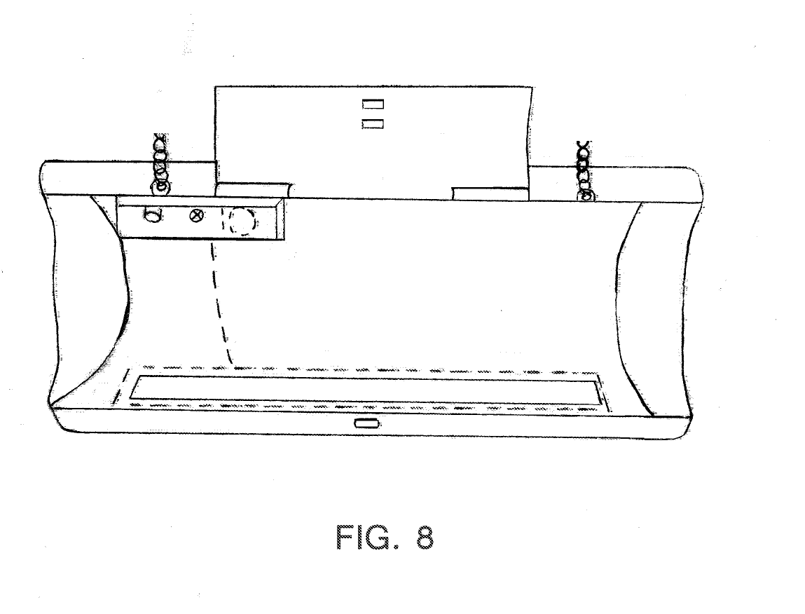

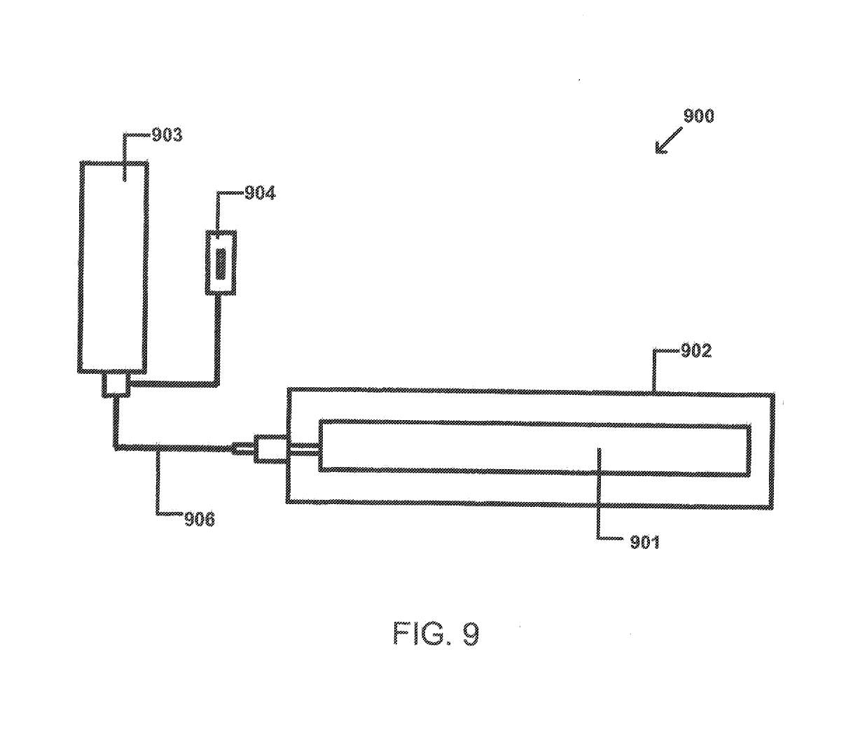

FIG. 9 illustrates an exemplary electroluminescent lighting system 900. The electroluminescent lighting system 900 includes an electroluminescent light strip 901, a transparent protective cover 902, a power system 903, a magnetic contact switch 904, and wires 905 that connect the power system 903 to the electroluminescent light strip 901 and the magnetic contact switch 904, respectively. The power system 903 includes a battery pack 905 (not shown) and a controller 906 (not shown). The controller 906 includes an integrated circuit board 907 (not shown) that regulates the power flowing from the battery pack 905 (not shown) to the electroluminescent light strip 901. The electroluminescent light strip 901 includes an inverter battery 908 (not shown), an inverter 909 (not shown), and one or more electroluminescent materials 910 (not shown).

FIG. 10 is a front view of an embodiment of a handbag 10. In this embodiment, the light source 3 (for example, an electroluminescent light) is on the sides and bottom of bag 10. The on/off switch 5 is connected through wiring 6 (a type of connecting device) within the lining of the bag 10 to a battery power pack 1 (a type of power source). The battery power pack 1 includes at least one disposable or rechargeable power cell connected through wiring 2 (a type of connecting device) within the lining of the bag 10 to light source 3. A protective covering 4 (such as a clear plastic layer, or mesh or fabric) protects the light source 3 from damage.

FIG. 11 shows an embodiment of the invention from a top view. The on/off switch 5 is connected through wiring 6 (not shown) within the lining of the bag 10 to a battery power pack 1 (a type of power source). The battery power pack 1 includes at least one disposable or rechargeable power cell connected through wiring 2 (not shown) within the lining of the bag 10 to light source 3. A protective covering 4 (such as a clear plastic layer, or mesh or fabric) protects the light source 3 from damage.

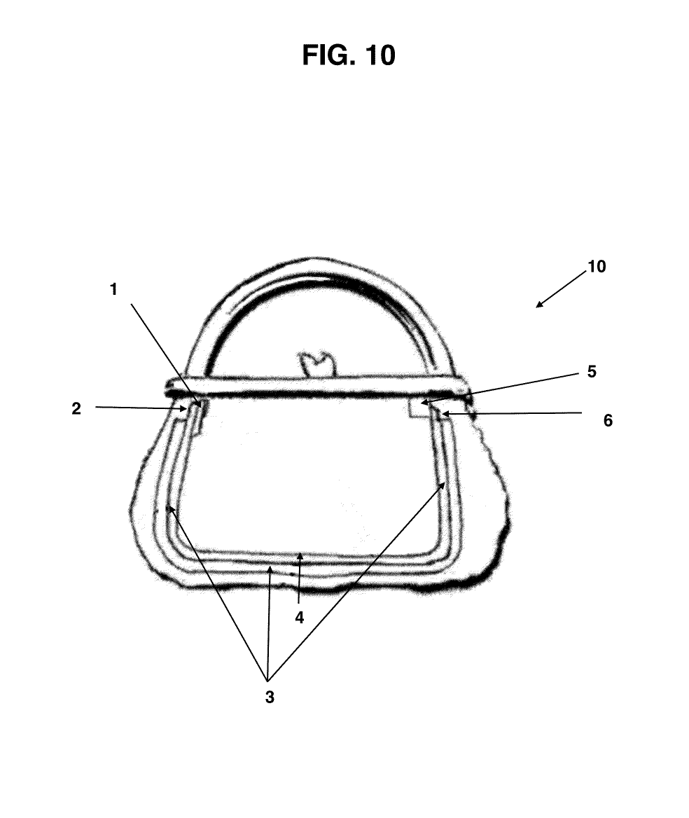

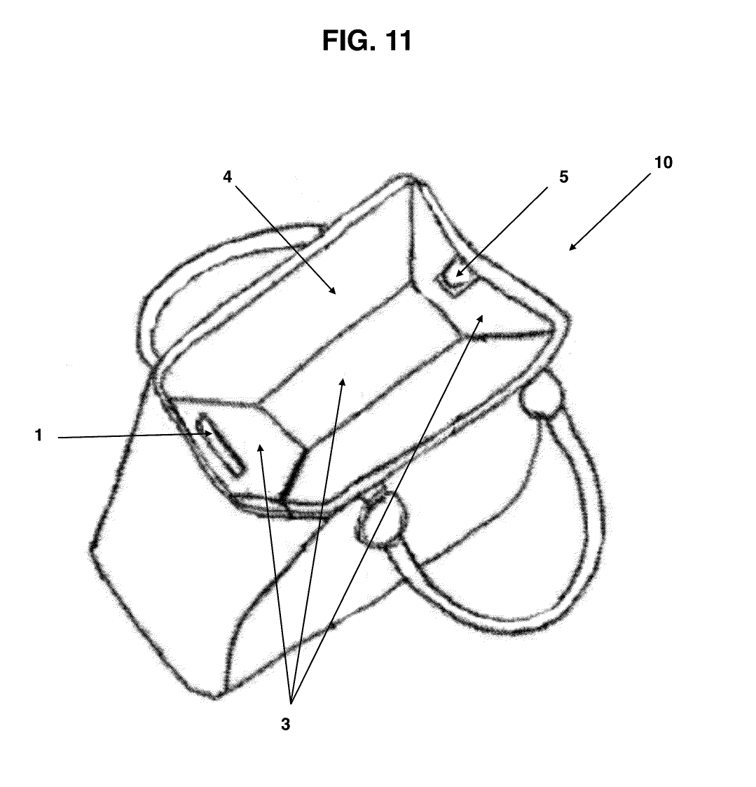

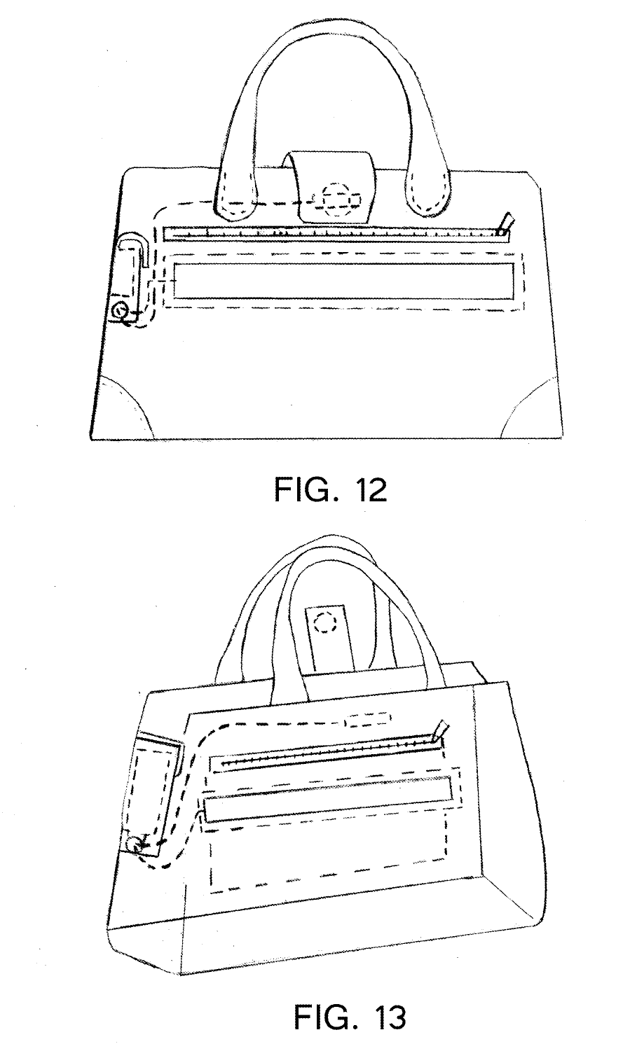

FIG. 12 is a cross-sectional side view of an embodiment of a handbag closed. In this embodiment, the on/off switch is connected through wiring (not shown) to a battery power pack (a type of power source). The battery power pack includes at least one disposable or rechargeable power cell connected through wiring (a type of connecting device) within the lining of the bag to light source. A protective covering (such as a clear plastic layer, or mesh or fabric) protects the light source from damage. A cloth lining covers the battery power pack, as well as the wiring. In this embodiment, the light source (for example, an electroluminescent light) is on the bottom of bag Grommet shown.

FIG. 13 shows an embodiment of a handbag from a top view. This embodiment is similar to the one in FIG. 12 in that the on/off switch is near battery power pack The battery power pack includes at least one disposable or rechargeable power cell connected through wiring (not shown) within the lining of the bag to light source Grommet also shown for wiring to flow through.

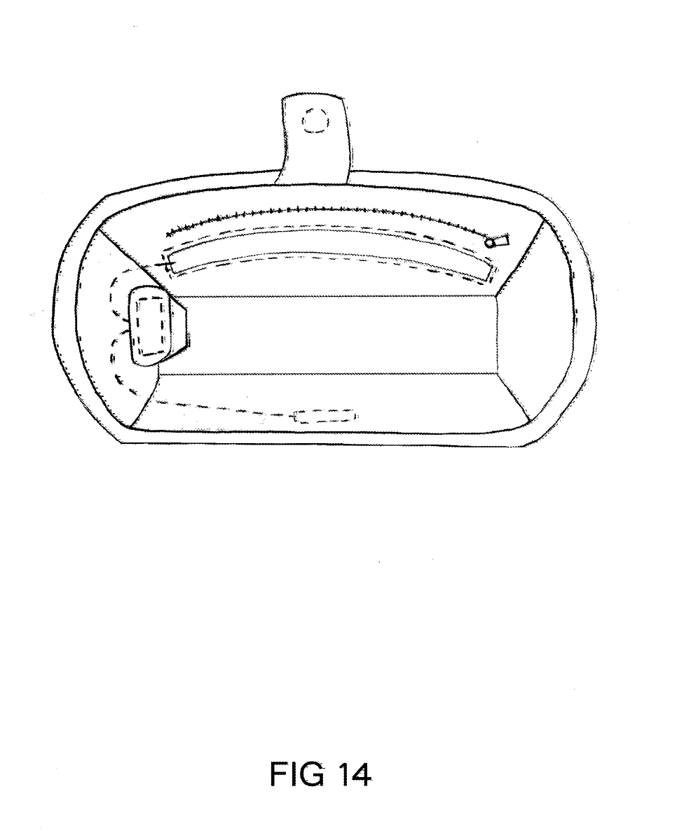

FIG. 14 is an open top view of an embodiment of a hand bag. In this embodiment, magnetic clasp, triggers the light source through wiring (not shown) in the lining of bag The battery power pack includes at least one disposable or rechargeable power cell. It is possible to use other types of clasps or even use the handle of a bag to trigger a light source.

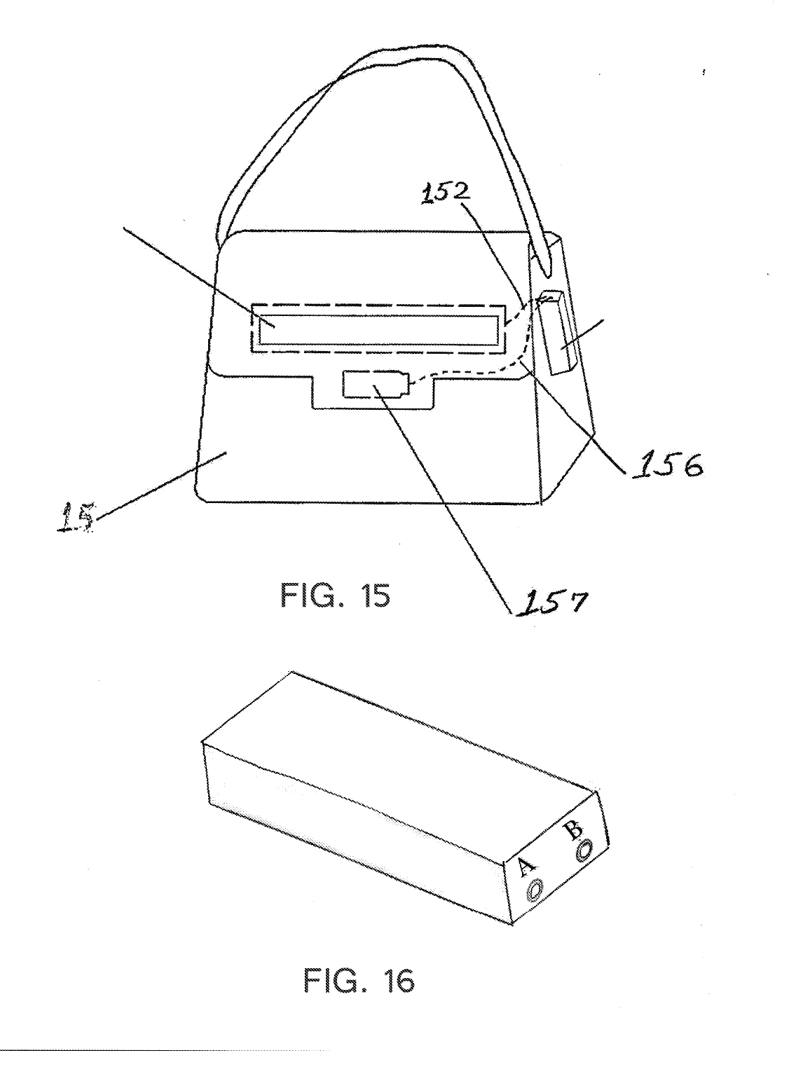

FIG. 15 is a front view of an embodiment of a handbag 15. In this embodiment, light source is connected through wiring 152 (a type of connecting device) in the lining of the bag 15 to battery power pack. In this embodiment, battery power pack is a battery driver and it has a circuit controller (not shown). Battery power pack is also attached through wiring 156 (a type of connecting device) in the lining of the bag 15 to an on/off switch 157. In this embodiment, switch 157 is in the form of a thin magnetic induction tube. It operates to automatically turn on light source when the bag 15 is opened. Both the magnetic induction tube 157 and the light source are very thin and generally range from about 0.2 mm to about 0.5 mm thick. This varies such that in one example it is 0.18 mm thick and in another it is lmm thick. These varying levels of thickness are considered thin. Also, both the magnetic induction tube 157 and the light source are flexible so that they can be bent into any shape and adapt to the shape and movement of the bag it is in. The light source is low in power consumption and can have a lifespan up to 25,000 hours.

FIG. 16 is a view of only a battery pack with A and B connection jacks (ports). A battery pack or driver. It has ports labeled “A” and “B”. One port receives wire 152 to connect the light source to the battery driver to power the light source (as shown in FIG. 15). The other port receives wire 156 to connect the magnetic induction tube 157 to the battery driver to power the magnetic induction tube 157 (as shown in FIG. 15).

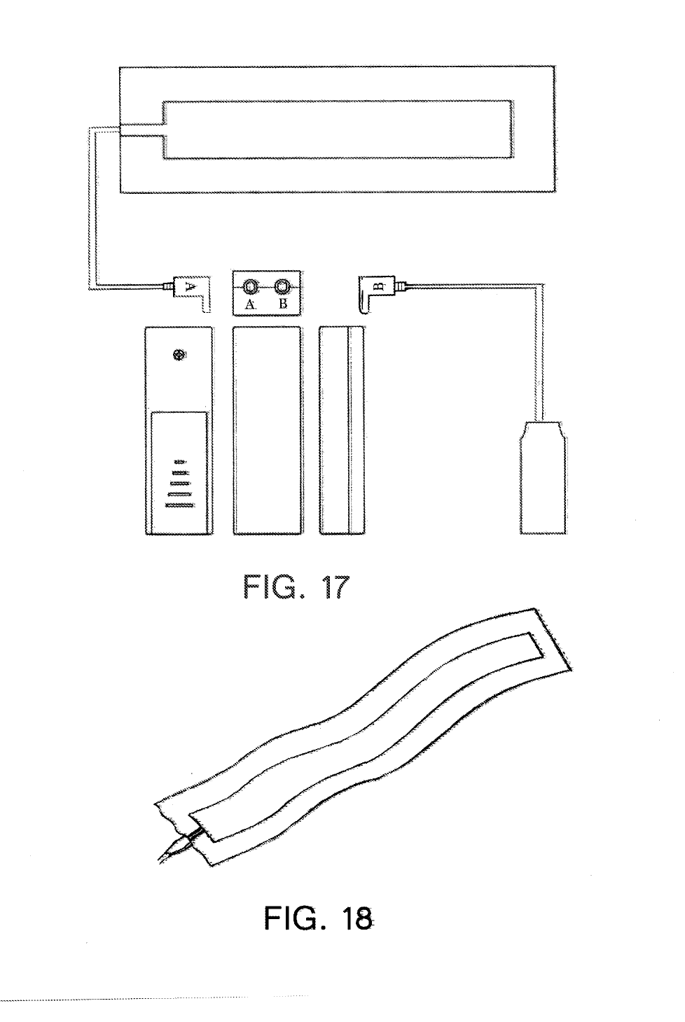

FIG. 17 is an embodiment of an electroluminescent lighting system. This example includes electroluminescent light strip, which is both heat resistant and machine washable to make it easier to clean the bag containing lighting system. Light strip is thin and flexible so that it can be bent into any shape and adapt to the shape and movement of the bag it is in. Additionally, in this example light strip has a protective UV laminated film covering. Light strip is ready to be connected by wire to battery driver via connection device. In this example, wire is about 250 mm long. When lighting system is used in a bag, it is helpful to conceal wire in the lining of the bag, so that it is hidden from view and does not get tangled with any of the items in the bag. Connection device is labeled “A” to indicate it should be plugged into port “A” of battery driver which is labeled for ease of usage. In the example shown in FIG. 17, a magnetic induction tube is ready to be connected by wire to battery driver via connection device. In this example, wire is about 500 mm long. When lighting system is used in a bag, it is helpful to conceal wire in the lining of the bag, so that it is hidden from view and does not get tangled with any of the items in the bag. Connection device is labeled “B” to indicate it should be plugged into port “B” of battery driver, which is labeled for ease of usage. In this example, magnetic induction tube is thin and measures approximately 20 mm wide by about 50 mm long by about 0.2 mm thick. This thin magnetic induction tube is flexible so that it can be bent into any shape and adapt to the shape and movement of the bag it is in. The battery driver in FIG. 17 is also relatively small and thin. In this example, it measures about 94 mm long by about 30 mm wide by about 20 mm thick. This example of a battery driver includes battery compartment which can hold any type of suitable replaceable or rechargeable battery (or batteries), for example, AA, AAA, C, D, 9 volt, etc. in any combination. In one embodiment, battery driver includes three AAA batteries, which are replaceable.

FIG. 18 is an example of a light source with a laminate edge for easy attachment to the bag (not shown) and a connecting device for connecting to a power source (not shown) and/or an on/off switch (not shown).

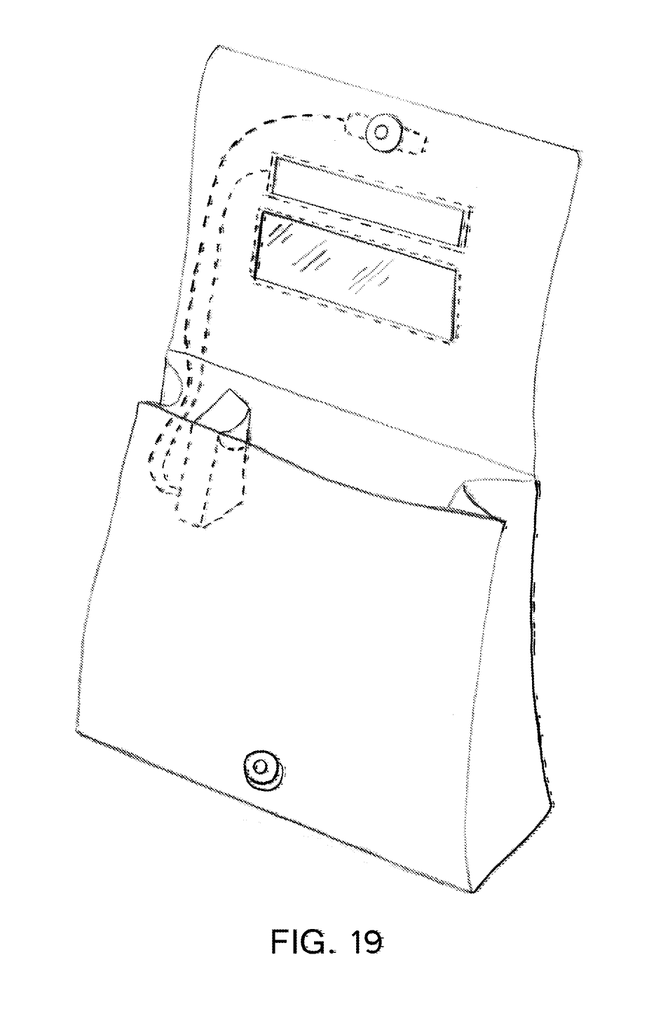

FIG. 19 shows a wire coming from behind battery pack to magnet closure, shows mirror.

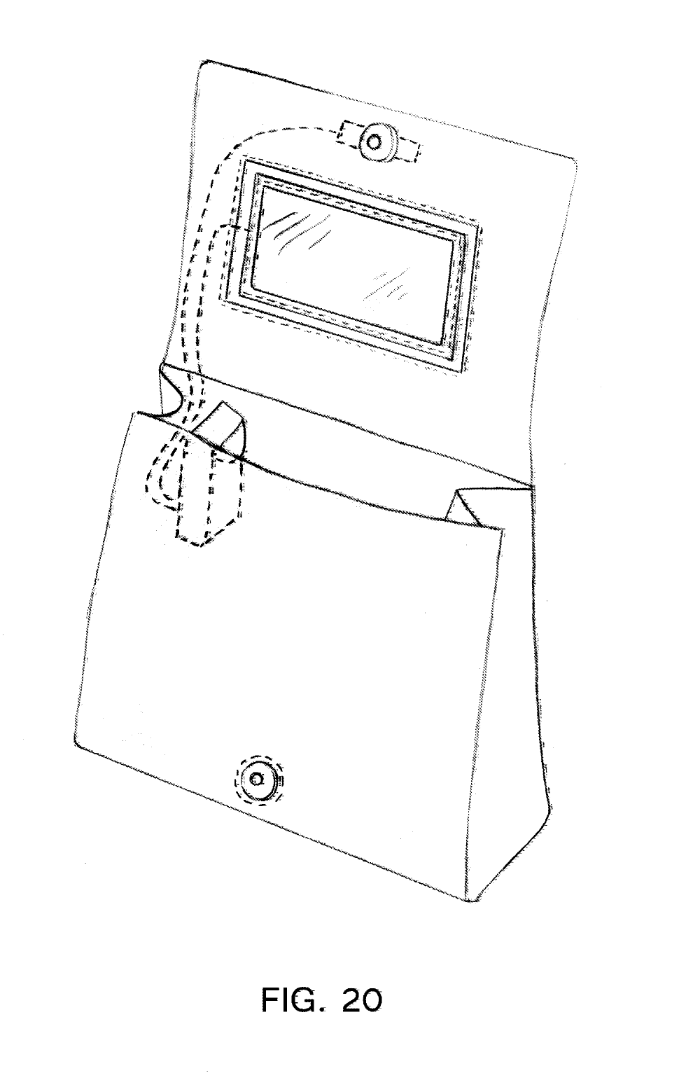

FIG. 20 shows the light panel top of a mirror.

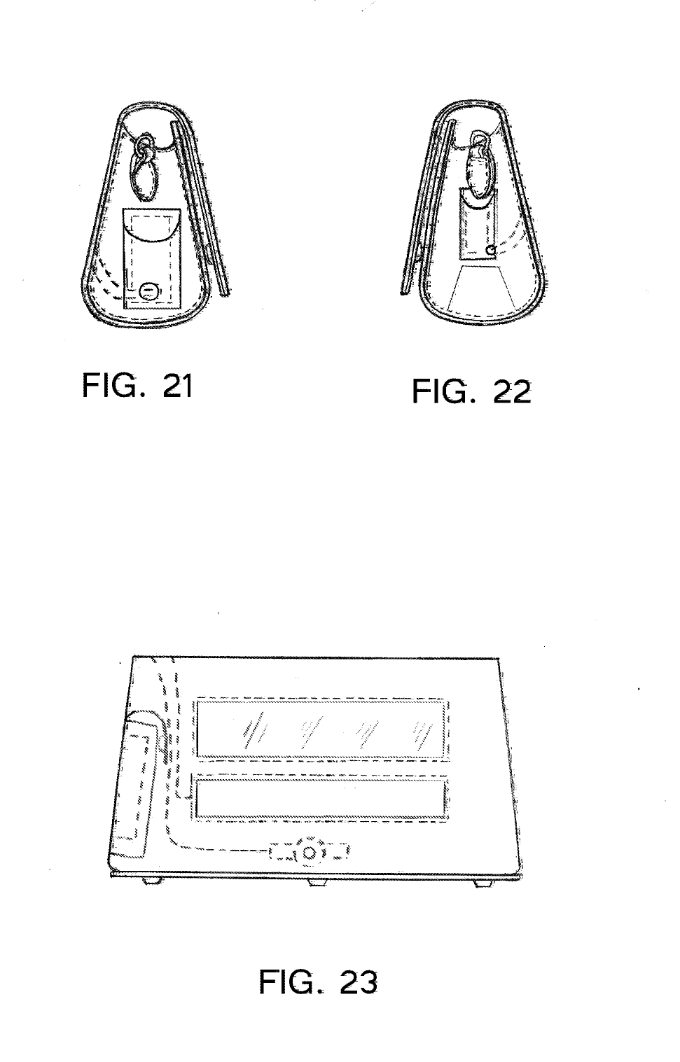

FIGS. 21-23 show three angles of a handbag with lighted mirror.

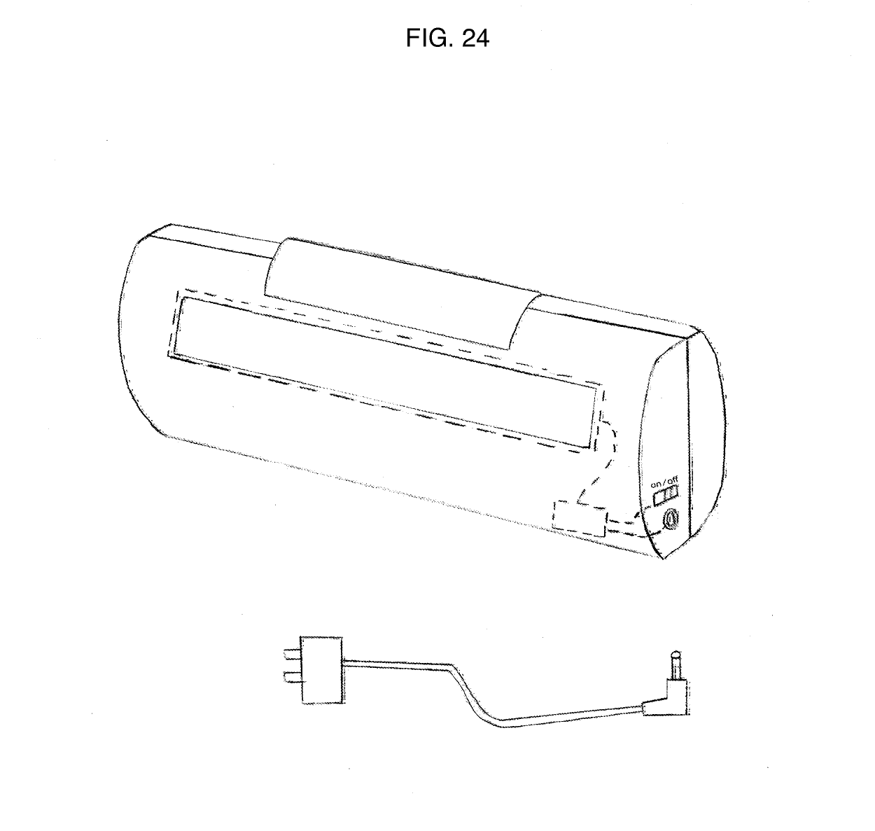

FIG. 24 shows a plug charger.

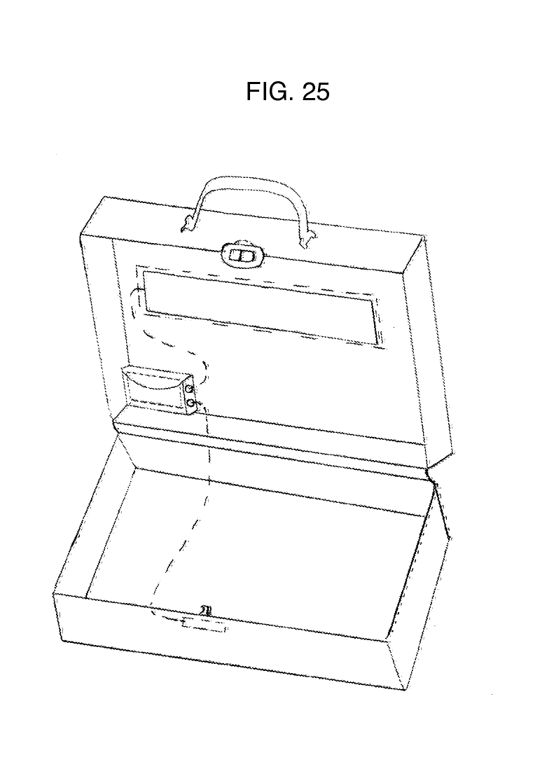

FIG. 25 shows a brief case.

FIGS. 26-33 show embodiments of the invention in luggage and depict various views with vertical lighting system. Other embodiments could be horizontal lighting system placement.

FIG. 26 is a top open view of lighting system vertical in luggage.

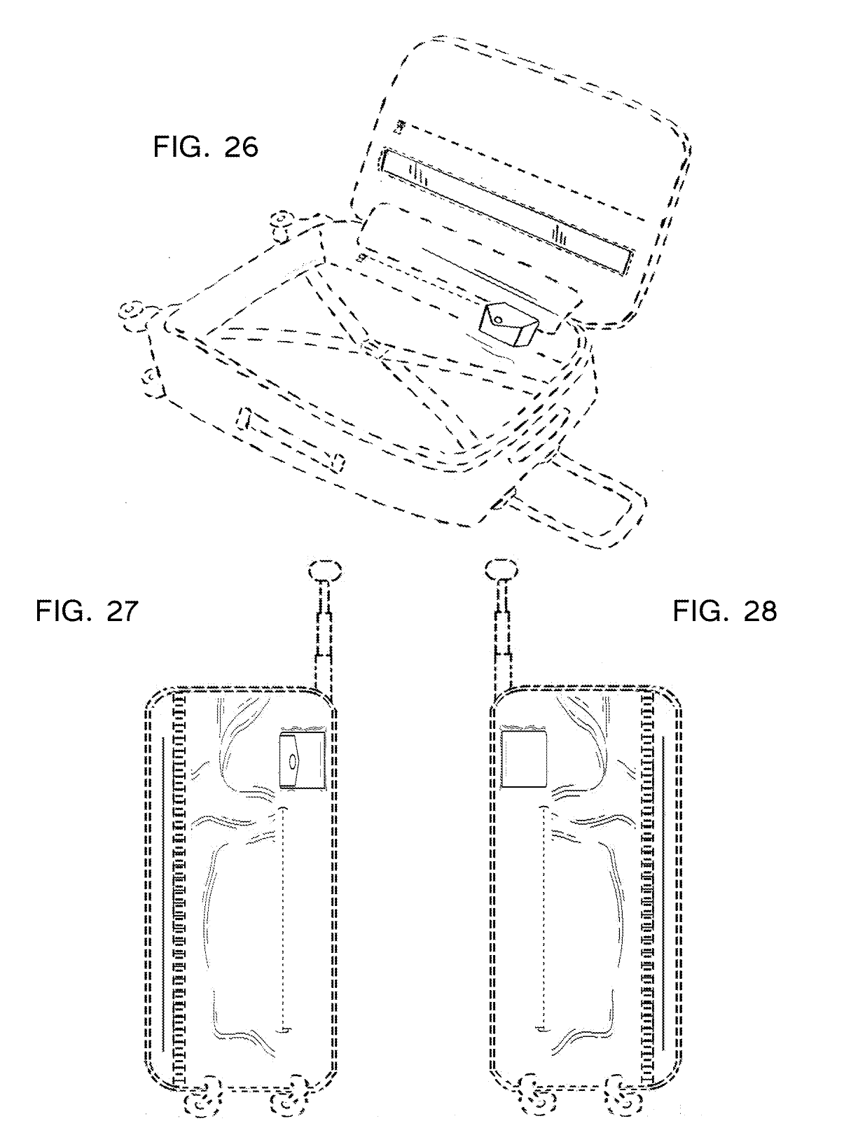

FIG. 27 is a left side view of lighting system vertical in luggage.

FIG. 28 is a right side view of lighting system vertical in luggage.

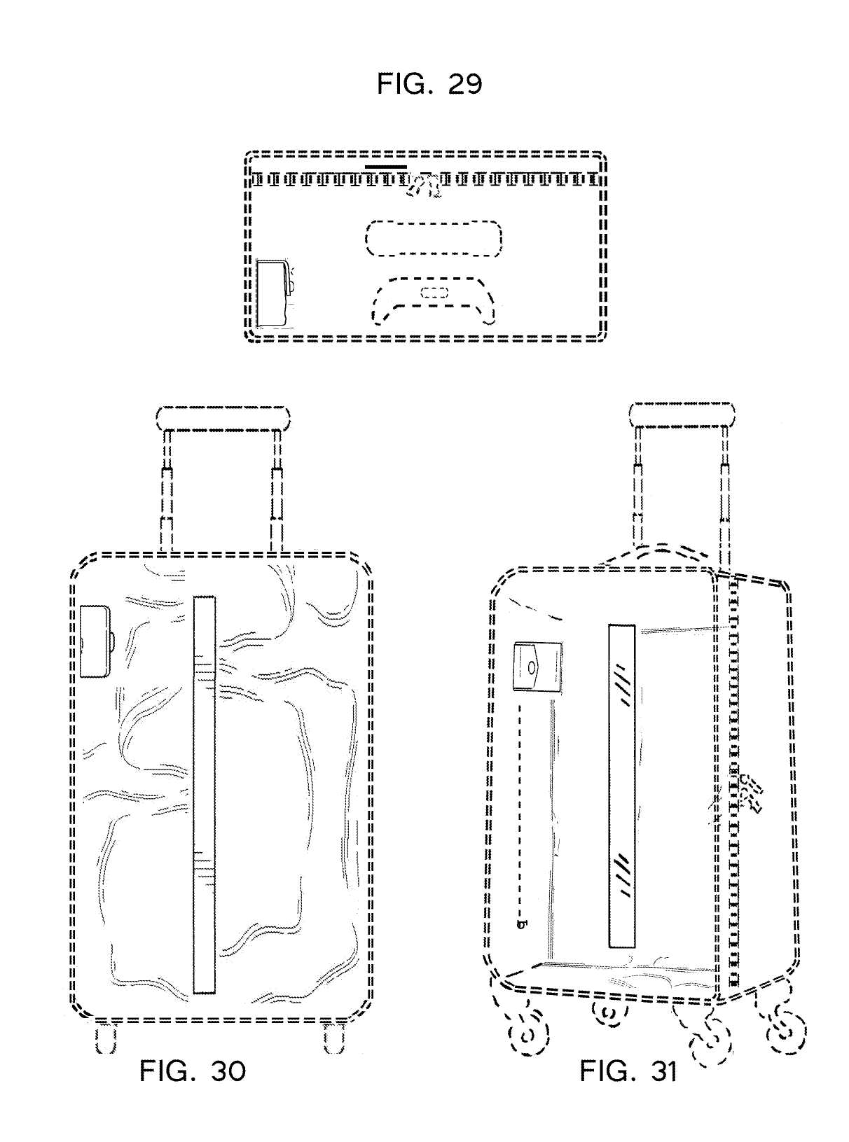

FIG. 29 is a top closed view of vertical lighting system in luggage.

FIG. 30 is a front view of vertical lighting system in luggage.

FIG. 31 is a front side angle view of vertical lighting system in luggage.

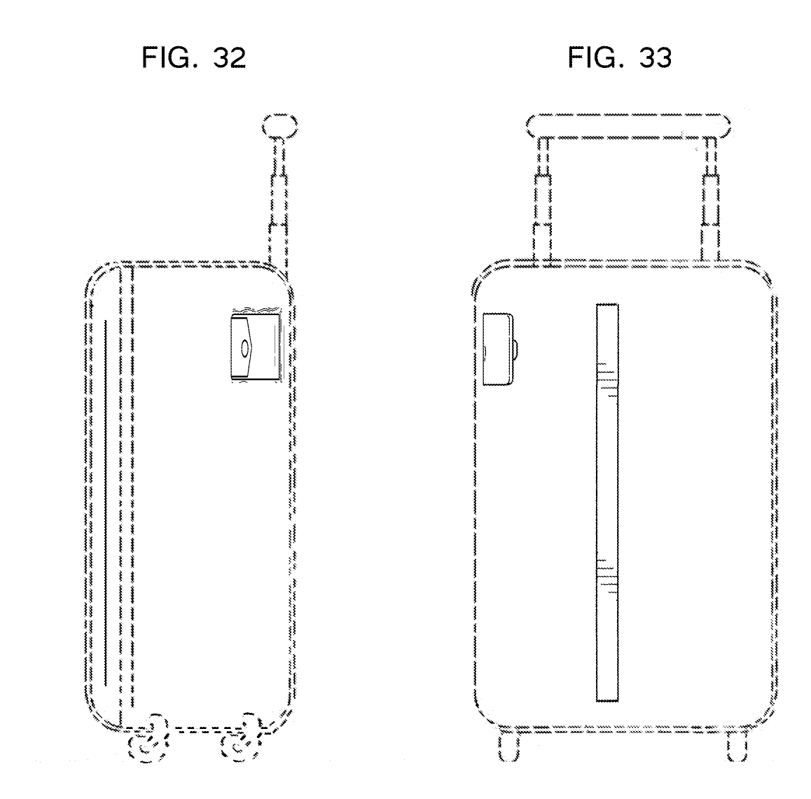

FIG. 32 is a side view of luggage with vertical lighting.

FIG. 33 is a front view of luggage with vertical lighting.

The type of light source can be in panel, wire and strip form. Any of these forms can be used in the invention as well as other forms not yet conventionally used.

Similarly, except as explicitly required by claim language, a single substance or component may meet more than a single functional requirement, provided that the single substance fulfills the more than one functional requirement as specified by claim language.

All patents, patent applications, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Additionally, all claims in this application, and all priority applications, including but not limited to original claims, are hereby incorporated in their entirety into, and form a part of, the written description of the invention.

Applicant reserves the right to physically incorporate into this specification any and all materials and information from any such patents, applications, publications, scientific articles, web sites, electronically available information, and other referenced materials or documents. Applicant reserves the right to physically incorporate into any part of this document, including any part of the written description, the claims referred to herein including but not limited to any original claims.

### DEFINITIONS

Unless otherwise indicated, the words and phrases presented in this document have their ordinary meanings to one of skill in the art.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the explanations given in this specification.

As used herein, the term “and/or” refers to any one of the items, any combination of the items, or all of the items with which this term is associated.

As used herein the phrase “battery pack” refers to a battery or a set of any number of (preferably) identical batteries or individual battery cells and additionally may comprise at least one of a housing, battery door, screw, wiring, wiring and/or plug(s), jacks, circuitry, plug device.

As used herein, the singular forms “a,” “an,” and “the” include plural reference unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements, or use of a “negative” limitation.

As used herein, the term “purse” refers to a container made of paper, cloth, mesh, metal, plastic or other flexible material.

As used herein, the term “coupled” means the joining of two members directly or indirectly to one another. Such joining may be stationary in nature or movable in nature and/or such joining may allow for the flow of fluids, electricity, electrical signals, or other types of signals or communication between two members. Such joining may be achieved with the two members or the two members and any additional intermediate members being integrally formed as a single unitary body with one another or with the two members or the two members and any additional intermediate members being attached to one another. Such joining may be permanent in nature or alternatively may be removable or releasable in nature.

As used herein, the terms “include,” “for example,” “such as,” and the like are used illustratively and are not intended to limit the present invention.

As used herein, the phrase “mechanically coupled” refers to bringing two or more items together or into relationship with each other in any number of ways including a direct or indirect physical connection that may be releasable (snaps, rivets, screws, bolts, welds, etc.), movable (rotating, pivoting, oscillating, etc.), or a combination thereof

As used herein, the phrase “operatively coupled” refers to bringing two or more items together or into relationship with each other such that they may operate together or allow transfer of information between the two or more items.

As used herein, the terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As defined within, the term “purse” refers to a receptacle, such as a handbag, pocketbook, or wallet that is used by a person to carry money and other small objects. As such, a purse can include, for example, a clutch, a tote, a briefcase, a handbag, a shoulder bag, or a makeup bag.

As used herein, the terms “front,” “back,” “rear,” “upper,” “lower,” “side”, “right,” and “left” in this description are merely used to identify the various elements as they are oriented in the FIGS, with “front,” “back,” and “rear” being relative apparatus. These terms are not meant to limit the element which they describe as the various elements may be oriented differently in various applications.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

As used herein, the term “bag” means any type of container handbag, purse, tote bag, briefcase, backpack. A bag can be described as a container of flexible and/or inflexible material, such as paper, plastic, or leather, that is used for carrying or storing items

As used herein, the term “panel” generally refers to a flat or curved component, typically rectangular, that forms or is set into the surface of a door, wall, or ceiling and/or is any shape, rectangular, square, triangular, circular.

As used herein, the term “strip” refers to a component that is more narrow and smaller than a panel.

As used herein, the terms “electroluminescent” and “electroluminescent light(s)” means a panel or strip or wire or other form, and can be an LED, LED light source, LED light panel, electroluminescent light source, edge-lit panel and/or a combination thereof

As used herein, the term “hue” means a gradation or variety of a color.

As used herein, the term “ambient light” means the light surrounding an environment or subject, and can also be called available light or existing light.

What is claimed:

1. A bag comprising:
an exterior surface and an interior surface;
a top portion, a bottom portion and one or more side portions;
at least one electroluminescent light source;
at least one light switch [coupled to the light, magnetic switch] for turning the at least one electroluminescent light source on and/or off;
a laminate covering for the at least one electroluminescent light source [laminated by heat, pressure, ultra violet (UV) light].

2. The bag of claim 1, wherein the light given off by the at least one electroluminescent light source is in a hue conducive to enabling vision in the presence of low ambient light.

3. The bag of claim 1, wherein the at least one electroluminescent light source comprises a flexible, elastic material.

4. The bag of claim 1, wherein the at least one electroluminescent light source is permeable or impermeable.

5. The bag of claim 1, wherein the at least one electroluminescent light source is located on at least one of the one or more side portions proximate the top portion.

6. The bag of claim 1, wherein the laminate covering extends beyond the perimeter of the at least one electroluminescent light source to form an edge of laminating material.

7. The bag of claim 1, further comprising an interior liner abutting the interior surface and the edge of laminating material being attached [any device for attaching, glue, sewing thread, Velcro, snaps, zippers] to the interior liner.

8. The bag of claim 7, wherein the at least one electroluminescent light is located between the interior surface and the interior liner.

9. The bag of claim 7, wherein the at least one electroluminescent light is mounted on the interior liner on the surface of the liner opposite the surface facing the interior surface of the bag.

10. The bag of claim 7, wherein the interior liner has an opening for displaying at least a portion of the at least one electroluminescent light source.

11. The bag of claim 1, wherein at least one of the at least one light switches is an automatic light switch which automatically turns on at least one of the at least one electroluminescent light sources in response to the bag being opened and/or in response to detecting a predetermined level of ambient light.

12. The bag of claim 1, wherein at least one of the at least one light switches is at least one manual light switch.

13. The bag of claim 12, wherein the bag has at least one opening and at least one of the at least one manual light switches is located at or near at least one of the openings in the bag.

14. The bag of claim 1, further comprising at least one of a permanent and/or removable battery.

15. The bag of claim 14, wherein the bag further comprises a pocket [can be affixed to the inside or outside of a bag] to hold the battery and wherein the battery further comprises a connector to connect the at least one battery to the at least one electroluminescent light source.

16. The bag of claim 15, wherein the pocket has an opening for the connector and/or an object connected to the battery to exit the pocket.

17. The bag of claim 16, wherein the opening in the pocket further comprises a protecting device.

18. The bag of claim 17, wherein the protecting device is a grommet [any material, metal, plastic, rubber, fabric, wood].

19. The bag of claim 17, wherein a battery pack additional comprised of A and B connection jacks (ports). A battery pack or driver has ports labeled “A” and “B”. One port receives wire to connect the light source to the battery driver to power the light source. The other port receives wire to connect the magnetic induction tube to the battery driver to power the magnetic induction tube.

20. The bag of claim 1, wherein the said light panel, showing durability of this light panel, and including the said wiring, are washable, water resistant, and heat resistant (can be placed in a washer and/or dryer) so that a simple removal of the said battery unit is all that is required to wash the whole bag including the light panel.

21. The bag of claim 1 additionally comprising at least one mirror.

22. The bag of claim 21, wherein the said at least one mirror is attached to the lining of the flap closure section of a bag, the said laminate covering and the said at least one electroluminescent light source encased in the laminate covering, is placed above, below, or partially or wholly surrounding the perimeter of the at least one mirror.

23. The bag of claim 1, wherein at least one electroluminescent light source is located on, or near, the top of the bag, or on more than one side portion, or most, or all of the entire perimeter of the inside of the bag, so to produce light which covers the entire perimeter of the inside and/or top of the bag.
